(19) United States
(12) Patent Application Publication
(10) Pub. No.: US 2015/0303704 A1
(43) Pub. Date: Oct. 22, 2015

(54) CHARGING SYSTEM AUTOMATICALLY SWITCHING BETWEEN WIRED CHARGING MODE AND WIRELESS CHARGING MODE, AND RELATED CHARGING CONTROL METHOD AND WIRELESS POWER RECEIVER CIRCUIT

(71) Applicant: MEDIATEK INC., Hsin-Chu (TW)

(72) Inventor: Kuan-Kai Juan, Hsinchu County (TW)

(21) Appl. No.: 14/642,758

(22) Filed: Mar. 10, 2015

Related U.S. Application Data
(60) Provisional application No. 61/980,052, filed on Apr. 16, 2014.

(51) Int. Cl. H02J 5/00; H02J 7/00; H02J 7/02

(52) U.S. Cl. CPC H02J 5/005; H02J 7/025; H02J 7/0052

(57) ABSTRACT

A charging system is provided. The charging system includes a wired power transmission path, a power management circuit and a wireless power receiver circuit. The power management circuit is coupled to the wired power transmission path. The wireless power receiver circuit is coupled to the wired power transmission path and the power management circuit, and is arranged for receiving a wireless power to generate an output power, and detecting whether a wired power is present in the wired power transmission path to selectively output the output power to the power management circuit.

### CROSS REFERENCE TO RELATED APPLICATIONS

This application claims the benefit of U.S. provisional application No. 61/980,052, filed on Apr. 16, 2014, the contents of which are incorporated herein by reference.

### BACKGROUND

The disclosed embodiments of the present invention relate to charging control, and more particularly, to a charging system automatically switching between a wired charging mode and a wireless charging mode, and a related charging control method and wireless power receiver circuit.

The wireless charging technique uses a change in the magnetic flux to transfer power from the primary coil (the transmission side) to the secondary coil (the reception side). The user needs not use a power cord to charge a portable electronic apparatus (e.g. a mobile phone). However, when the user connects the portable electronic apparatus to a wired power (e.g. the portable electronic apparatus is connected to a power cord) and a wireless power (e.g. the portable electronic apparatus is placed on a wireless charging pad) concurrently, a charging mode of the portable electronic apparatus needs to be determined.

Thus, there is a need for a charging control mechanism capable of determining a charging mode.

### SUMMARY

In accordance with exemplary embodiments of the present invention, a charging system automatically switching between a wired charging mode and a wireless charging mode, and a related charging control method and wireless power receiver circuit are proposed to solve the above-mentioned problem.

According to an embodiment of the present invention, an exemplary wireless power receiver circuit is disclosed. The exemplary wireless power receiver circuit comprises a wired power detector, a wireless power receiver and a controller. The wired power detector is coupled to a wired power transmission path, and is arranged for detecting whether a wired power is present in the wired power transmission path to generate a detection result. The wireless power receiver is arranged for receiving a wireless power to generate an output power. The controller is coupled to the wired power detector and the wireless power receiver, and is arranged for referring the detection result to control the wireless power receiver to selectively output the output power.

According to an embodiment of the present invention, an exemplary charging system is disclosed. The exemplary charging system comprises a wired power transmission path, a power management circuit and a wireless power receiver circuit. The power management circuit is coupled to the wired power transmission path. The wireless power receiver circuit is coupled to the wired power transmission path and the power management circuit, and is arranged for receiving a wireless power to generate an output power, and detecting whether a wired power is present in the wired power transmission path to selectively output the output power to the power management circuit.

According to an embodiment of the present invention, an exemplary charging control method is disclosed. The exemplary charging control method comprises the following steps: coupling a wireless power receiver circuit to a wired power transmission path; utilizing the wireless power receiver circuit to detect whether a wired power is present in the wired power transmission path to generate a detection result; and selectively outputting an output power from the wireless power receiver circuit according to the detection result.

The proposed charging control mechanism can realize the automatic switching between a wired charging mode and a wireless charging mode by adding a pluggable/removable wireless charging module without affecting the existing wired charging architecture. Hence, a charging system of an electronic apparatus can be expanded to include a wired charging mode and a wireless charging mode, and the cost for realizing the automatic switching between the wired charging mode and the wireless charging mode can be greatly reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an exemplary charging system according to an embodiment of the present invention.

FIG. 2 is an exemplary implementation of the charging system shown in FIG. 1.

FIG. 3 is a timing diagram of the output power shown in FIG. 2 according to an embodiment of the present invention.

FIG. 4 is another implementation of the charging system shown in FIG. 1.

FIG. 5 is a timing diagram of the power level received by the wired power detector shown in FIG. 4 according to an embodiment of the present invention.

FIG. 6 is a flow chart illustrating an exemplary charging control method according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “coupled” is intended to mean either an indirect or direct electrical connection. Accordingly, if one device is electrically connected to another device, that connection may be through a direct electrical connection, or through an indirect electrical connection via other devices and connections.

The proposed control mechanism may utilize a pluggable/removable wireless charging module to detect whether an electronic apparatus receives a wired charging power without affecting an existing circuit design of wired charging. When it is detected that the electronic apparatus is charged in a wired manner, the wireless charging module may not charge the electronic apparatus. In other words, the proposed control mechanism may realize the automatic switching between a wired charging mode and a wireless charging mode. Further description is provided below.

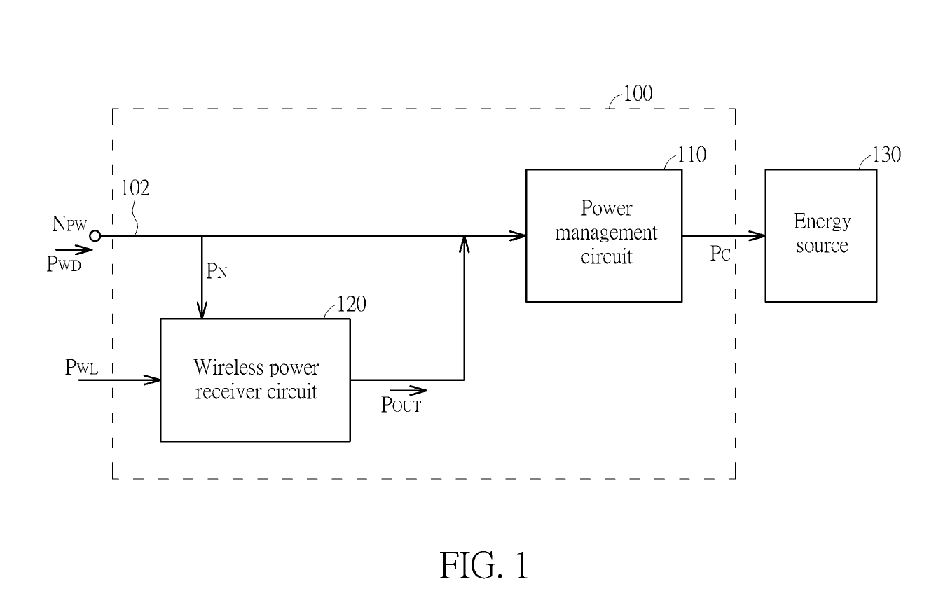

Please refer to FIG. 1, which is a block diagram illustrating an exemplary charging system according to an embodiment of the present invention. The charging system 100 may charge an energy source 130 (e.g. a battery) according to at least one of a wired power P_{WD} and a wireless power P_{WL}. In this embodiment, the charging system 100 may include a wired power transmission path 102, a power management circuit 110 and a wireless power receiver circuit 120. The power management circuit 110 is coupled to the wired power transmission path 102, wherein the wired power P_{WD} may be transmitted to the power management circuit 110 through the wired power transmission path 102. The wireless power receiver circuit 120 is coupled to the wired power transmission path 102 and the power management circuit 110, and is arranged for receiving the wireless power P_{WL} to generate an output power P_{OUT}, and detecting whether the wired power P_{WD} is present in the wired power transmission path 102 to selectively output the output power P_{OUT} to the power management circuit 110. For example, the wireless power receiver circuit 120 may receive a power level P_{N} (e.g. a voltage level) in the wired power transmission path 102, and accordingly detect whether the wired power P_{WD} is inputted into an input port (or an input node) N_{PW}. When it is detected that the wired power P_{WD} is inputted into the input port N_{PW}, the wireless power receiver circuit 120 may not output/generate the output power P_{OUT}; and when it is detected that the wired power P_{WD} is not inputted into the input port N_{PW}, the wireless power receiver circuit 120 may output the output power P_{OUT} to the power management circuit 110. Hence, the power management circuit 110 may receive one of the wired power P_{WD} and the output power P_{OUT} to generate a charging power P_{C}, and accordingly charge the energy source 130.

In one implementation, during detection of the wired power P_{WD}, the wireless power receiver circuit 120 may not receive the output power P_{OUT} through the wired power transmission path 102 while receiving the wired power P_{WD} through the wired power transmission path 102. This may prevent the detection of the wired power P_{WD} from being affected by the wireless power P_{WL}. By way of example but not limitation, the wireless power receiver circuit 120 may detect whether the wired power P_{WD} is present in the wired power transmission path 102 only when not outputting/generating the output power P_{OUT}.

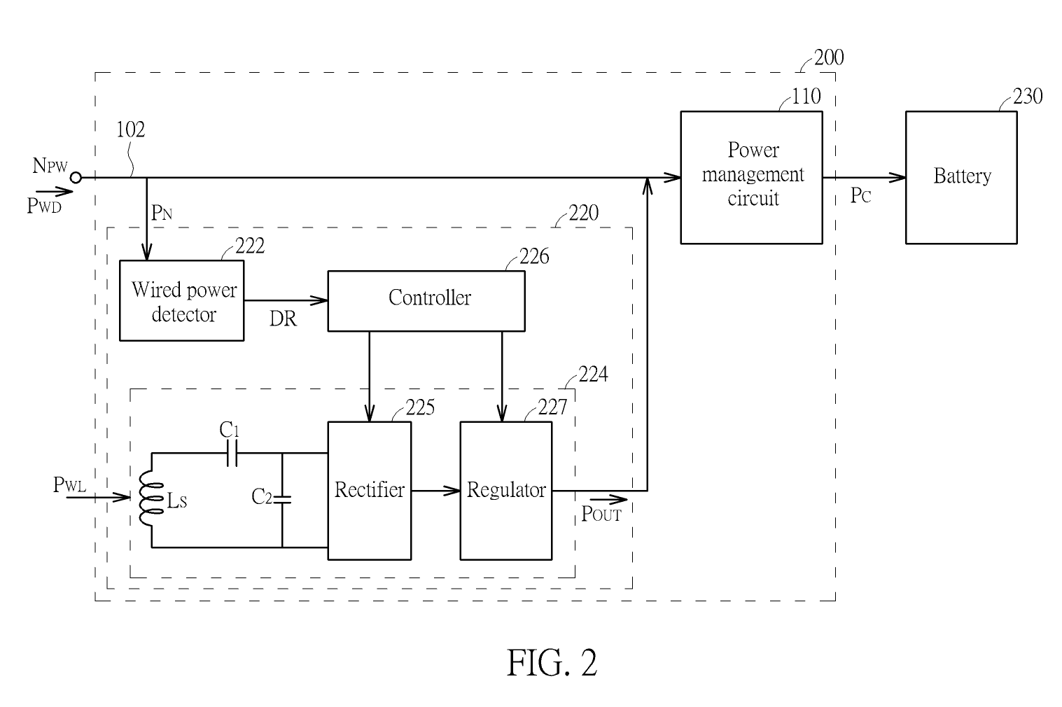

For better understanding of the present invention, a portable electronic apparatus having a charging system is given in the following for further description of the proposed charging control mechanism. However, a person skilled in the art should understand that the proposed charging control mechanism may be employed in other types of electronic apparatuses which can be charged in a wired manner. Please refer to FIG. 2, which is an exemplary implementation of the charging system 100 shown in FIG. 1. In this implementation, the charging system 200 is disposed in a portable electronic apparatus (e.g. a mobile phone; not shown in FIG. 2), and is arranged for charging a battery 230, wherein the charging system 100 shown in FIG. 1 may be implemented by the charging system 200, and the energy source 130 shown in FIG. 1 may be implemented by the battery 230. The charging system 200 may include, but is not limited to, the wired power transmission path 102 and the power management circuit 110 shown in FIG. 1 and a wireless power receiver circuit 220. In a case where the portable electronic apparatus is implemented by a mobile phone (not shown in FIG. 2), the input port N_{PW} may be a universal serial bus (USB) port used for receiving the wired power P_{WD}. Additionally, the wireless power receiver circuit 220 may be disposed on a back side of the mobile phone (e.g. disposed on aback cover have a wireless charging module disposed thereon) to receive the wireless power P_{WL} from a wireless power transmitter circuit (not shown in FIG. 2), thereby outputting the output power P_{OUT}. It should be noted that, as the back cover may be a removable cover, the mobile phone may maintain normal USB charging operations even though the user places the aforementioned back cover with another back cover where no wireless charging module is disposed thereon.

In the implementation shown in FIG. 2, the wireless power receiver circuit 220 may include, but is not limited to, a wired power detector 222, a wireless power receiver 224 and a controller 226. The wired power detector 222 is coupled to the wired power transmission path 102, and the controller 226 is coupled to the wired power detector 222 and the wireless power receiver 224. The wired power detector 222 maybe arranged for detecting whether the wired power P_{WD} is present in the wired power transmission path 102 to generate a detection result DR. The wireless power receiver 224 may be arranged for receiving the wireless power P_{WL} to generate the output power P_{OUT}. The controller 226 may refer the detection result DR to control the wireless power receiver 224 to selectively output the output power P_{OUT}. For example, when the detection result DR indicates that the wired power P_{WD} is present in the wired power transmission path 102, the controller 226 may control the wireless power receiver 224 not to output the output power P_{OUT}. In another example, when the detection result DR indicates that the wired power P_{WD} is not present in the wired power transmission path 102, the controller 226 may control the wireless power receiver 224 to output the output power P_{OUT}.

In addition, the wireless power receiver 224 may include, but is not limited to, a rectifier 225, a regulator 227, a coil L_{S} and a plurality of capacitors C₁ and C₂. The controller 226 maybe arranged for control respective operations of the rectifier 225 and the regulator 227. As a person skilled in the art should understand how the rectifier 225, the regulator 227, the coil L_{S} and the capacitors C₁ and C₂ operates to generate the output power P_{OUT}, further description is omitted here for brevity.

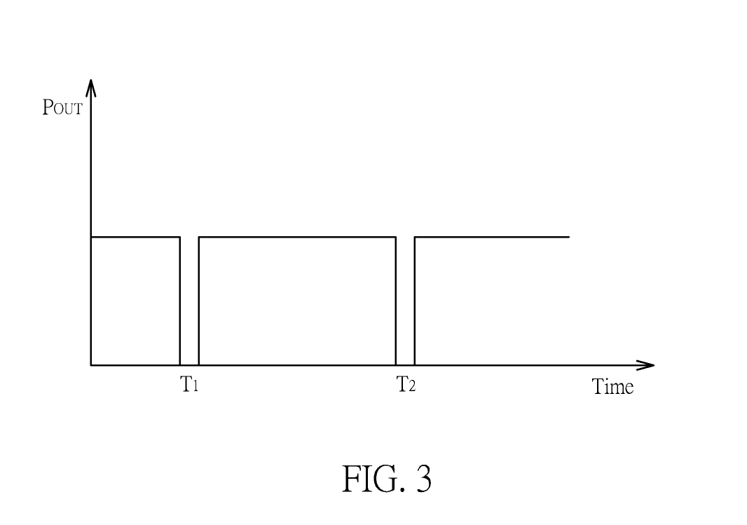

In order to determine whether the detected power level P_{N} is provided by USB charging (the wired power P_{WD}) or wireless charging (the wireless power P_{WL}/the output power P_{OUT}), the wired power detector 222 may perform detect the power level P_{N} before receiving the output power P_{OUT}. For example, the wired power detector 222 may detect whether the wired power P_{WD} is present in the wired power transmission path 102 only when the output power P_{OUT} has not been outputted from the wireless power receiver 224. Please refer to FIG. 3 in conjunction with FIG. 3. FIG. 3 is a timing diagram of the output power P_{OUT} shown in FIG. 2 according to an embodiment of the present invention. As shown in FIG. 3, the controller 226 may turn off the wireless power receiver 224 for a predetermined period of time (e.g. a period of time T₁ or a period of time T₂) to stop outputting the output power P_{OUT} (or adjust a power level of the output power P_{OUT} to a low level), and the wired power detector 224 may detect whether the wired power P_{WD} is present in the wired power transmission path 102 during the predetermined period of time. For example, the controller 226 may turnoff at least one of the rectifier 225 and the regulator 227 during the predetermined period of time, and the wired power detector 224 may detect the power level P_{N} so as to determine whether the wired power P_{WD} is present in the wired power transmission path 102.

It should be noted that the period of time T₁ and/or the period of time T₂ may be a period of time in which the wireless power transmitter circuit does not generate the wireless power P_{WL}. In other words, the wired power detector 222 detects whether the wired power P_{WD} is present in the wired power transmission path 102 during a predetermined period of time (e.g. the period of time T₁/T₂) in which the wireless power P_{WL} has not been received by the wireless power receiver 224. In brief, as long as the wired power detector 222 may detect wired power P_{WD} during a period of time in which the output power P_{OUT} has not been outputted, such modifications are also intended to fall within the scope of the present invention.

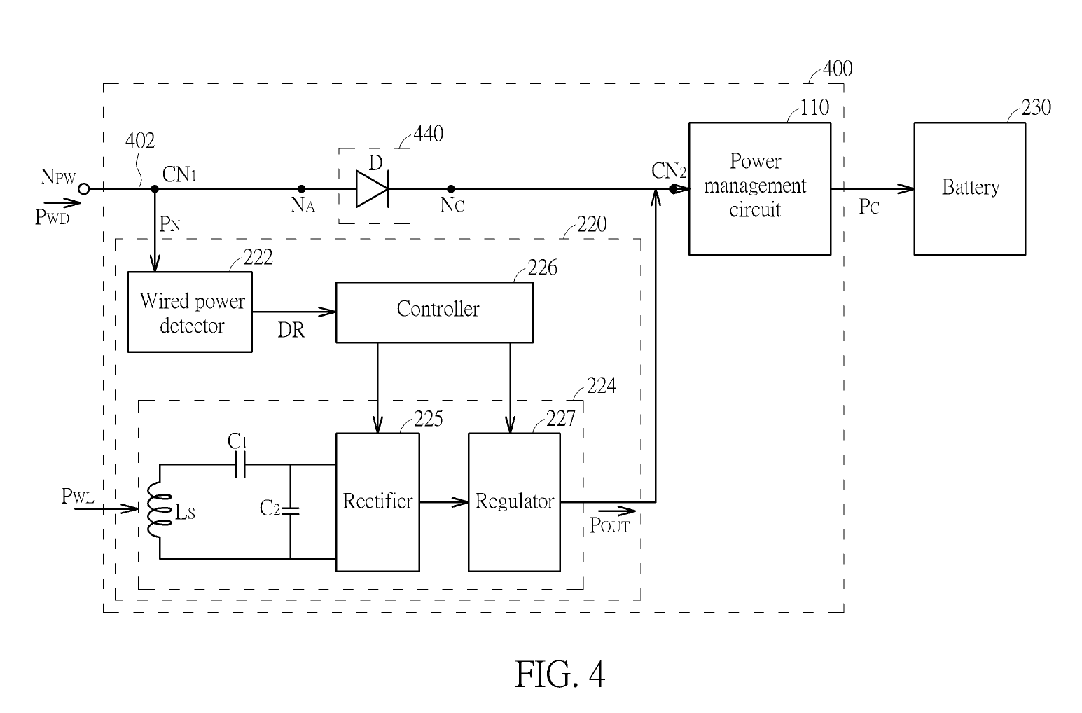

Please refer to FIG. 4, which is another implementation of the charging system 100 shown in FIG. 1. The architecture of the charging system 400 shown in FIG. 4 is based on that of the charging system 200 shown in FIG. 2, wherein the main difference is that a wired power transmission path 402 shown in FIG. 4 may include a plurality of connection nodes CN₁ and CN₂. The connection node CN₁ is coupled to the input port N_{PW} to receive the wired power P_{WD}, and the connection node CN₂ is coupled to the power management circuit 110. The wireless power receiver circuit 220 may detect whether the wired power P_{WD} is present in the wired power transmission path 402 through the connection node CN₁, and output the output power P_{OUT} to the power management circuit 110 through the connection node CN₂. While detecting the wired power P_{WD} through the connection node CN₁, the wireless power receiver circuit 220 does not receive the output power P_{OUT} through the connection node CN₁. By way of example but not limitation, the wired power transmission path 402 may further include a blocking element 440, which is coupled between the connection node CN₁ and the connection node CN₂ and is arranged for preventing the output power P_{OUT} from transmitting to the connection node CN₁. In this implementation, the blocking element 440 may be implemented by a diode D, wherein an anode N_{A} of the diode D is coupled to the connection node CN₁, and a cathode N_{C} of the diode D is coupled to the connection node CN₂. Please note that using the diode D to prevent the output power P_{OUT} from transmitting to the connection node CN₁ is for illustrative purposes only, and is not meant to be a limitation of the present invention. For example, the blocking element 440 may be implemented by a switch device.

In an alternative design, it is possible to prevent the output power P_{OUT} from transmitting to the connection node CN₁ without the use of the blocking element 440. For example, the wireless power receiver circuit 220 may detect whether the wired power P_{WD} is present in the wired power transmission path 402 through the connection node CN₁ during a period of time in which the output power P_{OUT} has not been outputted from the wireless power receiver circuit 220. In this example, the output power P_{OUT} received at the connection node CN₂ may has the signal waveform shown in FIG. 3.

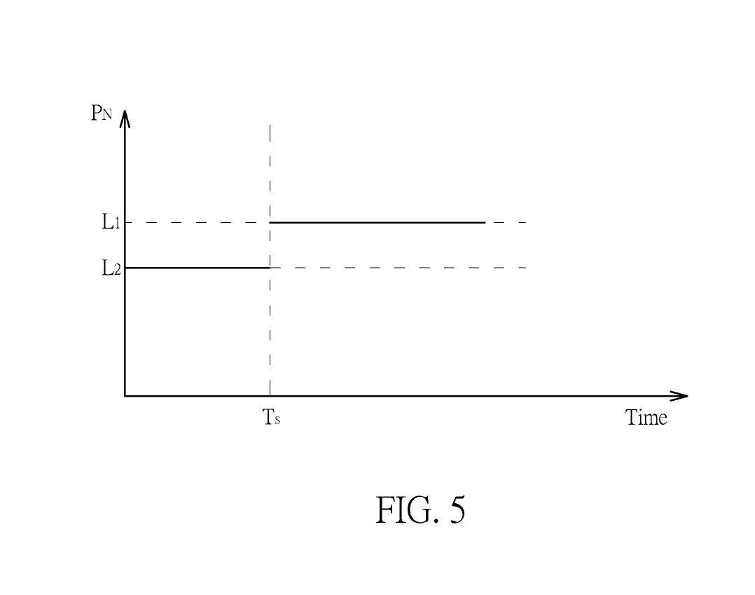

It should be noted that, in a case where a power received at the input port N_{PW} in a wired charging mode is different from a power provided by the wireless power receiver circuit 220 in a wireless charging mode of the mobile phone (i.e. a power level of the wired power P_{WD} is different from a power level of the output power P_{OUT}), the wireless power receiver circuit 220 may directly detect the power level P_{N} in the wired power transmission path 402 (a power level at the connection node CN₁) to generate the detection result DR even though the no blocking element is disposed in the wired power transmission path 402. This may also realize charging control mechanism capable of automatically switching charging modes. Please refer to FIG. 5 in conjunction with FIG. 4. FIG. 5 is a timing diagram of the power level P_{N} received by the wired power detector 222 shown in FIG. 4 according to an embodiment of the present invention. In this embodiment, before a point in time T_{S}, the power management circuit 100 may receive the output power P_{OUT} (having a power level L₂) to generate the charging power P_{C} to thereby charging the battery 230 in a wireless manner. When the user connects a power cord to the input port N_{PW} at the point in time T_{S}, the wired power detector 222 detects that the power level P_{N} increases to a power level L₁ (a power level of the wired power P_{WD}), and the controller 226 may stop outputting the output power P_{OUT} according to the detection result DR. Please note that, although the timing diagram shown in FIG. 5 illustrates that the wireless charging mode is switched to the wired charging mode, a person skilled in the art should understand that the charging system 400 may switch the wired charging mode to the wireless charging mode by detecting variations of the power level P_{N}. Further description is omitted here for brevity.

Although the wired power detection is illustrated with reference to the charging system 200 shown in FIG. 2 and the charging system 400 shown in FIG. 4, this is not meant to be a limitation of the present invention. In an alternative design, the wireless power receiver 224 shown in FIG. 2/4 maybe implemented by different circuit architectures. Further, the charging system 100 shown in FIG. 1 may employ the charging control mechanism described with reference to FIGS. 2-5 to realize the automatic switching between the wired and wireless charging modes.

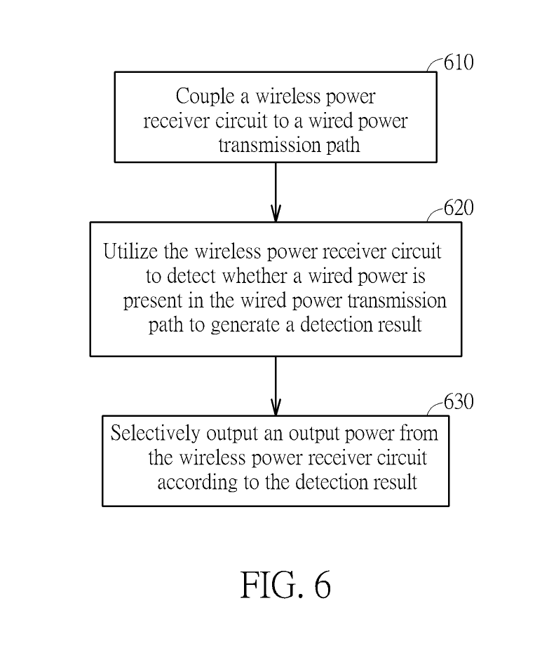

The aforementioned charging control mechanism may be summarized in FIG. 6, which is a flow chart illustrating an exemplary charging control method according to an embodiment of the present invention. Provided that the result is substantially the same, the steps are not required to be executed in the exact order shown in FIG. 6 and are not required to be contiguous. In other words, other steps can be intermediate. To facilitating understanding of the proposed charging control method, the flow chart shown in FIG. 6 is described with reference to the charging system 100 shown in FIG. 1. The method may be summarized as below.

Step 610: Couple the wireless power receiver circuit 120 to the wired power transmission path 102.

Step 620: Utilize the wireless power receiver circuit 120 to detect whether the wired power P_{WD} is present in the wired power transmission path 102 to generate the detection result DR.

Step 630: Selectively output the output power P_{OUT} from the wireless power receiver circuit 120 according to the detection result DR.

In one implementation, step 620 is performed only when the output power P_{OUT} has not been not outputted from the wireless power receiver circuit 120. In another implementation, while step 620 is performed, the wireless power receiver circuit 120 does not receive the output power P_{OUT} from the wired power transmission path 102. In still another implementation, when the power level of the wired power P_{WD} is different from the power level of the output power P_{OUT}, the wireless power receiver circuit 120 may determine whether to perform wired charging or wireless charging according to the detected power level P_{N}. As a person skilled in the art should understand the operation of each step of the charging control method shown in FIG. 6 after reading the above paragraphs directed to FIGS. 1-5, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless power receiver circuit, comprising:
a wired power detector, coupled to a wired power transmission path, the wired power detector arranged for detecting whether a wired power is present in the wired power transmission path to generate a detection result;
a wireless power receiver, arranged for receiving a wireless power to generate an output power; and
a controller, coupled to the wired power detector and the wireless power receiver, the controller arranged for referring the detection result to control the wireless power receiver to selectively output the output power.

2. The wireless power receiver circuit of claim 1, wherein when the detection result indicates that the wired power is present in the wired power transmission path, the controller controls the wireless power receiver not to output the output power.

3. The wireless power receiver circuit of claim 1, wherein when the detection result indicates that the wired power is not present in the wired power transmission path, the controller controls the wireless power receiver to output the output power.

4. The wireless power receiver circuit of claim 1, wherein the wired power detector detects whether the wired power is present in the wired power transmission path only when the output power has not been outputted from the wireless power receiver.

5. The wireless power receiver circuit of claim 4, wherein the controller further turns off the wireless power receiver for a predetermined period of time, and the wired power detector detects whether the wired power is present in the wired power transmission path during the predetermined period of time.

6. The wireless power receiver circuit of claim 4, wherein the wired power detector detects whether the wired power is present in the wired power transmission path during a predetermined period of time in which the wireless power has not been received by the wireless power receiver.

7. The wireless power receiver circuit of claim 1, wherein the wireless power receiver is coupled to the wired power transmission path, a power level of the wired power is different from a power level of the output power, and the wired power detector detects a power level in the wired power transmission path to generate the detection result.

8. A charging system, comprising:
a wired power transmission path;
a power management circuit, coupled to the wired power transmission path; and
a wireless power receiver circuit, coupled to the wired power transmission path and the power management circuit, the wireless power receiver circuit arranged for receiving a wireless power to generate an output power, and detecting whether a wired power is present in the wired power transmission path to selectively output the output power to the power management circuit.

9. The charging system of claim 8, wherein the wired power transmission path comprises:
a first connection node, arranged for receiving the wired power, wherein the wireless power receiver circuit detects whether the wired power is present in the wired power transmission path through the first connection node; and
a second connection node, coupled to the power management circuit, wherein the wireless power receiver circuit outputs the output power to the power management circuit through the second connection node;
wherein while detecting the wired power through the first connection node, the wireless power receiver circuit does not receive the output power through the first connection node.

10. The charging system of claim 9, wherein the wireless power receiver circuit detects whether the wired power is present in the wired power transmission path through the first connection node during a period of time in which the output power has not been outputted from the wireless power receiver circuit.

11. The charging system of claim 10, wherein the wired power transmission path comprises:
a blocking element, coupled between the first connection node and the second connection node, the blocking element arranged for preventing the output power from transmitting to the first connection node.

12. The charging system of claim 11, wherein the blocking element is a diode, an anode of the diode is coupled to the first connection node, and a cathode of the diode is coupled to the second connection node.

13. A charging control method, comprising:
coupling a wireless power receiver circuit to a wired power transmission path;
utilizing the wireless power receiver circuit to detect whether a wired power is present in the wired power transmission path to generate a detection result; and
selectively outputting an output power from the wireless power receiver circuit according to the detection result.

14. The charging control method of claim 13, wherein when the detection result indicates that the wired power is present in the wired power transmission path, the output power is not outputted from the wireless power receiver circuit.

15. The charging control method of claim 13, wherein when the detection result indicates that the wired power is not present in the wired power transmission path, the output power is outputted from the wireless power receiver circuit.

16. The charging control method of claim 13, wherein the step of utilizing the wireless power receiver circuit to detect whether the wired power is present in the wired power transmission path to generate the detection result is performed only when the output power has not been not outputted from the wireless power receiver circuit.

17. The charging control method of claim 13, wherein the step of coupling the wireless power receiver circuit to the wired power transmission path comprises:
coupling a first connection node of the wired power transmission path to the wireless power receiver circuit, wherein the wireless power receiver circuit detects whether the wired power is present in the wired power transmission path through the first connection node; and
coupling a second connection node of the wired power transmission path to the wireless power receiver circuit, wherein the wireless power receiver circuit outputs the output power through the second connection node.

18. The charging control method of claim 17, wherein the step of utilizing the wireless power receiver circuit to detect whether the wired power is present in the wired power transmission path to generate the detection result comprises:
during a period of time in which the output power has not been outputted from the wireless power receiver circuit, utilizing the wireless power receiver circuit to detect whether the wired power is present in the wired power transmission path through the first connection node.

19. The charging control method of claim 17, wherein while the step of utilizing the wireless power receiver circuit to detecting whether the wired power is present in the wired power transmission path to generate the detection result is performed, the charging control method further comprises:
preventing the output power from being transmitted from the second connection node to the first connection node.

20. The charging control method of claim 17, wherein a power level of the wired power is different from a power level of the output power, and the step of utilizing the wireless power receiver circuit to detecting whether the wired power is present in the wired power transmission path to generate the detection result comprises:
detecting a power level at the first connection node to generate the detection result.
